(19) United States
(12) Patent Application Publication
(10) Pub. No.: US 2010/0147688 A1
(43) Pub. Date: Jun. 17, 2010

(54) 2-IN-1 BIOCHIP

(76) Inventor: Mohamed Roshdy Soliman El Hadidy, Cairo (EG)

Correspondence Address: FITCH EVEN TABIN & FLANNERY, 120 SOUTH LASALLE STREET, SUITE 1600, CHICAGO, IL, 60603-3406, US

(21) Appl. No.: 12/161,114

(22) PCT Filed: Jan. 19, 2006
(86) PCT No.: PCT/EG2006/000003

§ 371 Date: Jul. 16, 2008

(51) Int. Cl. G01N 27/00; B01D 57/02

(52) U.S. Cl. 204/452; 204/603

(57) ABSTRACT

This invention relates to the Capillary Electrophoresis (CE) Biochip. This chip uses the technology of CE combined with conductivity detection to determine: blood Electrolytes (EL) of K3 Na, Ca & Li using “EL Biochip” and to monitor water quality using “L Biochip”. Our in use technology enables to develop a small chip, reliable, easy to use, inexpensive and capable for rapid whole blood testing anywhere. Once this technique is developed, a generic system is obtained, and multitude of ions can be tested at once on the same device. Our chips are using same hardware (layout) and can be optimized to test other ions. The “2-in-1 Biochip” is a multi application versatile system, having two chips : “EL Biochip” : a point-of-care blood analysis chip, for diagnosis & therapeutic follow-up. “L-Biochip”: an on-site environmental monitoring liquids chip, to monitor water quality & guarding against water born diseases outbreaks.

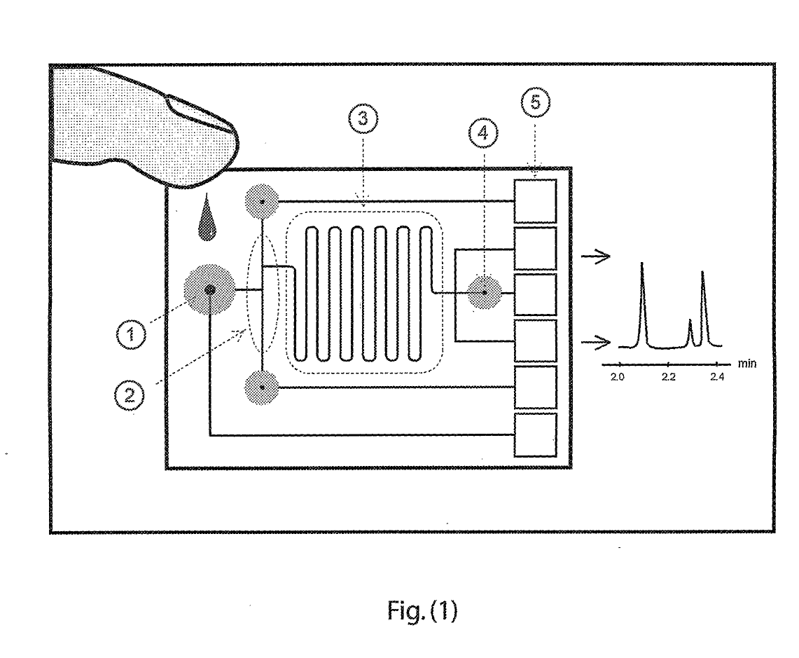

### BACKGROUND

In year 2000, the applicant of this patent Dr. El-Hadidy applied for a patent of “Na K Biochip,” and in 2002 obtained an Egyptian patent certificate No. 22236 EG.

In 2003, the applicant presented a paper about the “Na K Biochip” patent to the 8^{TH} Commercialization of Micro/Nano Systems Conference COMOS 2003:, 8-11 September 2003, Amsterdam, The Netherlands. The presentation has triggered the interest on the levels of both academics¹ and industrials² till now. ¹ Even recently, regarding “MicroTech & Nano Tech Commercialization Forum” in Melborn Australia December 2004, President of MANCEF e-mailed me saying: “I would be happy to use your Biochip as an example in my presentation . . .” It was done.² Abbot, the famous broad-based health care company e-mailed to me on 18 Nov. 2005 the following: . . . your technology is very interesting . . . This is an evidence of the continuing interest in this innovation.

This positive response encouraged the patent applicant to enhance the Biochip performance to cope with actual market demand.

The applicant introduces “2-in-1 Biochip” which is composed of 2 co-chips using same hardware:
“EL Biochips” to test blood Electrolytes (EL) of: K, Na & Ca, for diagnosis, and Lithium (Li)³ for therapeutic follow-up. ³ Lithium is a drug widely used for treatment of manic-depressive illnesses. This drug requires regular blood serum monitoring because it has serious toxic effects at high concentration levels.
   Our “EL Biochip” would allow easy therapeutic monitoring of Li level in blood by “pointing-of-care” doctor, or even by the patient himself.
“L Biochip” to test Liquids (L), for monitoring water quality & guarding against water born diseases outbreaks.

### TECHNICAL FIELD

### Introduction

### 1. Background Art:

Different Clinical Blood Analysis:

Diagnostics of many diseases require human blood testing to be carried out in clinical laboratories, Blood analysis uses different methods including: electrical, spectroscopy, chemical, photometry . . .

Analytical methods for quantifying human blood electrolytes of Sodium, Potassium, Calcium & Lithium: Routine clinical methods for the determination of blood electrolytes includes: Flame emission photometry, atomic absorption spectroscopy, Electrochemical methods, and use of Ion-Selective Electrodes (ISE).

To determine blood electrolytes in serum or plasma, ISE became the most commonly used method because of its suitability for combined testing and automation. But ISE response is logarithmic which may cause selectivity problem, and is not a generic system.

A more general separation technique of Capillary Electrophoresis (CE) can be applied, because potentially it is more selective and experiences less from interferences. Moreover, CE is a generic system capable to measure several ions at once on the same device without need for selective electrodes or any further human intervention. Our biochip uses CE technique.

Following the trend of point-of-care blood testing, patients and physicians would welcome a single-use disposable (SUD) testing biochip and hand-held analyzers, which can be used for point-of-care.

Those hand-held analyzers perform similar or even better than their counterparts conventional analyzers, which are mostly: large, fragile, more expensive and of course non-portable.

Currently, there are point-of-care analyzers using mostly cartridges with various detection principles. For example using miniaturized ISE combined with conductivity detection.

### 2. Shortcomings of Background Art:

Different Kinds of Clinical Blood Analysis

Manual Clinical Blood Analysis:
In case of accomplishing clinical blood analysis manually the result will be inaccurate, taking longer time and needs more effort.
The improper way of getting rid of the analysis residues could pollute the environment.
The conventionally large sized analyzers are fragile, non-portable and expensive.
Generally the cost of the analyses is rather expensive.

Hand-Held Analyzers Using Cartridge System:
The earlier analyzer models were not portable, but the new models became portable and are using disposable cartridge for testing blood constituents. The cartridge is similar to our biochip, and both of them need measuring instrument to show the test results.
The earlier models of cartridge analyzers had the following shortcoming:

The cartridge is rather expensive compared to the biochip, and it needs to be stored in a fridge. The cartridge measuring instrument (analyzer) is considerably expensive compared to that of the biochip. Moreover it is non-portable, large and fragile, besides not usable anywhere which is a crucial issue.

This presents a hurdle for expansion and limits its use, which distances it from achieving goals similar to those achievable by the biochip. It is also noteworthy that the technology of ion selective electrodes cannot attain a generic system as that of our biochip.

### 3. The New in the Innovation:

The “2-in-1 Biochip” is a Multi Applications Versatile System Having Two Chips:
“EL Biochip”: a point-of-care blood analysis chip for early diagnosis & therapeutic follow-up. It is optimized to test blood Electrolytes (EL) of Potassium (K), Sodium (Na), Calcium (Ca) & Lithium (Li). Testing of K, Na & Ca in blood are often required to diagnose several diseases and for emergencies anywhere.

The Li is used for therapeutic follow-up during the treatment of manic-depressive illnesses.
The methods of use: is to put drop of whole blood in the biochip inlet and connect it to a small hand-held measuring instrument (analyzer) to give quick result. The measurement is so easy, enabling physicians for point-of-care testing or even the patients to do it by themselves.
“L Biochip”: an environmental on-site liquids monitoring chip. It is optimized to monitor water quality to control its suitability for drinking and guarding against water born diseases outbreaks.

Tap water cations: K, Na, Ca & Mg

Tap water anions: Cl, SO₄ & HCO₃
Both EL & L biochips have multi applications versatile system, using same single hardware layout.
Using more general separation technique of Capillary Electrophoresis (CE), is capable to test several ions at once on the same chip without need for selective electrodes or any further human intervention.
The “2-in-1 biochip” use Capillary Electrophoresis (CE) technique combined with conductivity detection.

Mainly, we are dealing with inorganic constituents
The use of CE technique leads to develop a small high performance biochip: fast, easy to use, reliable, inexpensive, usable anywhere, and environmental friendly.
For the sake of general applicability, this invention avoids separate development of electrolyte components (e.g unlike ISE). And once developed, a generic system is obtained that is easily adopted for other ions.
Our biochip system is prepared to be usable for point-of-care anywhere (Decentralization). This important capability is much needed and increases the market demand considerably:
   ∘ In the developed countries, auto-analyzers are generally used for centralized locations. For decentralized point-of-care locations (anywhere) the biochip system can be used.
   ∘ In the developing countries, usage of the biochip will not be limited only to the “point-of-care”, but will extend to be used in the enormous numbers of small clinical laboratories, which are not using auto analyzers and suffer from instrumentations and reagents problems. The biochip is considerably inexpensive and will be in the reach of limited income patients, consequently enhanced healthcare services
Applying the CE principle, in our particular practical application, for “point-of-care” blood analysis and environmental “on-site” monitoring, is a new innovation. This is not an easy task, due to the challenge of sophisticated requirements and confronting problems such as: concentration mismatch, interferences, advanced multifunction on a single chip, decentralization usability, . . .
Many of the components and principles used in the chip are not completely new, but the miniaturization and physical integration of the different aspects on the chip, in addition to balancing the various components create a complex technical problem that require a great deal of creativity and effort to get the desirable results.
Progress in life science gained recently enormous push by the introduction of chip-based technology. This has been achieved by using advances in micro fabrication technique first pioneered by microelectronic industry. Accordingly two devices were developed: “microfluidics” biochips in analogy with “microelectronics” chip, and DNA arrays. Those two devices are playing an important role to develop and to enable viable commercialization of genomics, drugs discovery and developing the fields of bio-medical/pharma, and (early) diagnostics.
The “Biochip” (lab-on-a-chip) is similar to “microfluidics” device using CE system. It is related to those outstanding promising fields of genomics and proteins, but not exactly the same. It is modified to be applied for “point-of-care” clinical diagnostics and for environmental “on-site” monitoring.
Accordingly we developed the following “2-in-1 Biochips”:
   ∘ “EL Biochip: to test blood Electrolytes (EL)
   ∘ “L biochip” to test liquids (L). It is optimized for water monitoring, since water is basic for life.
It is worthy to mention here that the achievements of our inexpensive EL & L chips, including usable anywhere, could be the outcome of targeting point-of-care use and embedding commercialization in the R&D work from the very beginning, considering the indirect positive impact on human factors and population welfare as a favorite appealing background.
Human aspects of our biochip:
   ∘ The chip allows early diagnosis to save lives.
   ∘ Usable anywhere spreads healthcare services everywhere.
   ∘ Monitoring the quality of water is important, since it is vital to human health and basic for life.
   ∘ The chip enables therapeutic follow-up to ensure safe treatment.
   ∘ Using the chip for on-site water monitoring allows to guard against water born diseases outbreaks
   ∘ Inexpensive chip will be in the reach of limited income patients, enhancing healthcare services for all.
   ∘ The chip is environmental friendly.

### 4. Advantages of the New Art:

Brief Summary:
Small size, lightweight, quick accurate results, superior performance, user-friendly, inexpensive, required for many diseases and emergencies, environmental friendly, reliable. The chip being small, user friendly, and the apparatus is portable, inexpensive and affordable for the majority of user will allow general use anywhere.

A. Blood Testing of Na & K:
To be used for early diagnostics of many diseases, such as renal and heart failure, electrolyte unbalance, diarrhea fatal to children, cholera, dehydration, . . .
Decentralized useable anywhere: remote places, in ambulance, beside patients bed, point-of-care, intensive care, open heart operations, . . .
Cost effective & economically attractive

B. Blood Testing of Calcium:
Calcium is vital for strong bones and teeth, and for the health of the heart, muscles and nerves. It plays an important role in tissue repair and the control of blood pressure and acidity. Getting enough calcium is especially important during: menopause, pregnancy, and breast-feeding, as well as for elderly men & women.
Our biochip tests the ionized Ca, which is required for diseases such as:
   Rickets (childhood disease caused by deficiency of vitamin D and sunlight associated with impaired metabolism of calcium and phosphorus) for children
   Osteomalacia (abnormal softening of bones caused by deficiencies of phosphorus or calcium or vitamin D) for elders
   Osteoporosis (abnormal loss of bony tissue resulting in fragile porous bones attributable to a lack of calcium) for women.
   Hypo, hyper parathyraidism [inadequate secretion of parathyroid hormone resulting in abnormally low levels of calcium in the blood, and excessive secretion of parathyroid hormone resulting in abnormally high levels of calcium in the blood; can affect many systems of the body (especially causing bone resorption and osteoporosis)]

Hence the biochip is serving wide categories of people:
children, women and elders.

C. Blood Testing of Lithium:

Under normal conditions, lithium is not present significantly in the human blood, although lithium is widely used as a drug to treat psychiatric illness of manic-depression. It is noticed that the value of the therapeutic index, which is ratio between the toxic concentration and the therapeutic concentration, is very low. Because of this it is crucially important to monitor lithium concentration in the patient blood through out the period of lithium medication, to guard against toxic concentration. This is a therapeutic follow-up.

Liquids Testing Including Water:

Water is the most common liquid on the earth and is basic for life.
Worldwide, almost 1.2 billion people lack access to safe drinking water, and twice that many lack adequate sanitation. As a result, the World Health Organization WHO estimates that 3.4 million people, mostly children, die every year from water-related disease.
Even where water treatment is widely practiced, constant continually watching is required to guard against waterborne disease outbreaks.
In the natural drinking water cation (K, Na, Ca & Mg) & anion (CL, SO₄ & HCO₃) balance is considered an indication of the suitability of human use of water. High concentration of cation & anion species affect the taste of drinking water.
Tap water is to be corrosive to the piping system affected by the calcium and magnesium concentrations.
The “L Biochip” is optimized to analyze water, enabling to control its suitability for drink use or for sanitation. The common used technique for water analysis is ion chromatography. While the “L Biochip” is using CE technique combined with conductivity detection is a viable alternative for water analysis, enjoying the miniaturization advantages as mentioned before, in addition to faster separation, better on-site performance and higher resolution.

Water:

When dealing with water, it may be convenient to have a brief background about it, as follows:
The main sources of used water are surface water and groundwater.
70% of earth's surface is covered by water. Most of it is unusable ocean water. Fresh water is only 3% of all water, 2% is unavailable frozen in the polar ice, and the remaining 1% is accessible fresh water.
Water treatment is widely practiced to keep tap water safe for consumption, and to guard against waterborne disease outbreaks. Well-known pathogens are controlled with chlorination.
If the public water supply is contaminated, it may transmit infections, which cause serious fatal diseases such as diarrhea and cholera.
Mainly, developing countries suffer from water quality. Mostly in those countries the untreated sewage is discharged in rivers. In turn, these rivers are used often for drinking and personal sanitation. Using the “L Biochip” to monitor water quality enable safe drinking water and to guard against waterborne diseases.
Hard water: is determined by Ca & Mg concentrations. To use hard water is a problem, as it forms a deposited layer inside the pipes and on heating elements. Also it is not suitable for soap washing, as it does not foam but form precipitates.

### 5. Disclosure of Invention

Roots of the Invention:
Introduction of chip-based technology enabled biochip science to develop microfluidics biochips using Capillary Electrophoresis (CE) separation, to be applied for analysis. From the beginning CE micro fluidics are mainly used in the field of life science, to analyse proteins, DNA & RNA.
The “2-in-Biochip” (lab-on-a-chip) is similar to CE microfluidics device, but not exactly the same. It is modified to be applied for “point-of-care” clinical diagnostics anywhere, and for environmental “on-site” monitoring.

The Modification:
Regarding the separation system, the CE separation technique can be used for organic and inorganic substances, since it is suitable and advantageous for both.
Regarding detection system, the conventional life science chip uses optical detection as it suits the organic substances. But in our case of diagnostic, mostly we are dealing with inorganic ions which are best tested using conductivity detection, since many of them cannot be tested directly with optical methods. Also conductivity detection fulfills the requirement for clinical diagnosis anywhere and on-site monitoring.

The CE Separation & Conductivity Detection:
The “2-in-1 Biochips” use CE technique combined with conductivity detection. The separation of ions by CE is based on the migration of changed species in an electrolyte of +^{ve} cations and −^{ve} anions moving in opposite directions under action of externally applied electric field.
CE is a generic separation system enabling multitude of ions to be tested at once on the same device. The length of separation channel affects separation efficiency, and can be of about a centimeter for rapid separation.
Using conductivity detection enables to have simple biochip, which is user friendly. Also it is a non-selective detection (unlike ISE) suitable for decentralized point-of-care testing anywhere, which is a crucial issue for our biochip.
The space available inside the capillary restricts the size of the electrodes. So, it can be formed by depositing a thin conducting layer inside the capillary. The geometry of the electrodes measuring the conductivity affects the sensitivity.
It is possible to have contact less conductivity detection, which permits freedom in placing the electrodes more than the case of using contact detection. But this may reduce the resolution and sensitivity.

Concentration Mismatch:
Using CE separation for blood samples containing high ionic concentration of constitutions, degenerate the separating performance, due to the resulting mismatch between sample and background electrolyte (BGE). To avoid this problem there are different approaches.
In case of high concentration, a simple method is to dilute the sample. The point-of-care usage requires that automatic dilution is to be done direct on the chip. This can be done using electroosmetic flow (EOF) to pump and mix sample with a dilute.
An alternative solution for mismatch is to increase BGE concentration, by adding to it sodium chloride having appropriate concentration.

“L Biochip” to Monitor Water Quality:
To monitor the drinking water quality requires determining both cations and anion species.
Drinking water major cations and anions are:
Cations K, Na, Ca & Mg
Anions Cl, SO₄ & HCO₃
The CE “L Biochip” can be used to separate and detect both cations +^{ve} ions and anions −^{ve} ions in separate CE runs.
Cationic ions are to be separated with co-migrating electroosmetic flow (EOF)
Anionic separation requires to reverse the direction of EOF. This can be accomplished by separating in a BGE containing CTAB (Cetyltrimethylamonium bromide).
And also by reversing the polarity of the voltages.
Cations and anions can be analyzed “in separate CE runs” or to analyze them “simultaneously”, according to choice. We choose to analyze “in separate CE run” to enable applying the same “L Biochip” hardware layout to monitor drinking water quality. This means that our biochip system is “Versatile” and suitable for the analysis of different +^{ve} and −^{ve} ions.

### BRIEF DESCRIPTION OF THE CHIP DRAWING

See FIG. (1)

The 2-in-1 Biochip is a small size integrate device that has an inlet for blood (or liquid) and has connecting terminals. It comprises:
(1) Micro dialysis membrane to filter blood serum.
(2) Double-T injection loop to transfer the blood (or liquid) to the separation channels
(3) Capillaries for electrophoretic separation.
(4) Conductivity detector electrodes with associated contacts, and interconnecting channels.
(5) Connecting terminals

Finally the biochip is mounted in a cartridge together with control means and calibration mean V,1/2

Utilization (Making Use) of the Invention

To produce the “2-in-1 Biochip” and to use it in the related fields of application.

The “2-in-1 Biochip” Characteristics Sum Up

The study of the “2-in-1 Biochip” was not an easy task due to the challenge of sophisticated targeting which creates a complex technical problems that requires a great deal of creativity and effort to get the desirable results.

The new innovation gives to the in use technology system extra dimensions that enhances and widen the domain of applications.

Hence our Biochip patent is comprehensive having distinctive characteristics that comprise: generic technique, versatile applicability, and decentralized usability.

Generic Technique:

Once our in use CE technology is developed, a generic system is obtained, which can be applied to make similar chips for other ions, and enables to test multitude of ions at once on the same device.

Versatile Applicability:

Using of the same chip hardware layout for duality (that characterizes nature) and multitude of applications such as:

Blood diagnoses & liquid monitoring, analyze both cations & anions, usable inside & outside clinical laboratories for “point-of-care”, . . .

Whelming Decentralization Usability Anywhere:

Our biochip system can be used directly anywhere and has a potential prospect of high demand. This is a unique “whelming decentralization usability” form other than the current in use “point-of-care” one. Decentralization is a significant requirement of the 21^{st} century.

1-6. (canceled)

7. A biochip for testing blood and liquids for elements by using capillary electrophoresis (CE) combined with conductivity detection, comprising:
an inlet port for tested liquid;
a micro-membrane for filtration;
a separation capillary channel for electrophoretic separation of ionic elements; and
electrodes with associate contacts for conductivity detection and voltage supply.

8. The biochip of claim 7, wherein the biochip is a blood analyzing biochip.

9. The biochip according to claim 8, wherein the elements are: Potassium (K), Sodium (Na), Calcium Ca), Lithium (Li) and other blood elements.

10. The biochip according to claim 9, wherein the membrane is a micro-dialysis membrane.

11. The biochip according to claim 7, wherein the liquid is water tested for anions of Chloride (Cl), Sulfate (SO4) and Bicarbonate (HCO3).

12. The biochip according to claim 7, wherein the liquid is water tested for cations of Potassium (K), Sodium (Na), Calcium (Ca) and Magnesium (Mg).

13. A method of testing liquids for a multitude of elements simultaneously on a single biochip according to claim 7, by capillary electrophoresis (CE) combined with conductivity detection, comprising:
placing a drop of liquid to be tested in the biochip inlet;
connecting the integrated device to an analyzer; and
detecting various ions in the liquid by conductivity detection.

14. The method according to claim 13, wherein the liquid is blood and wherein the elements are: Potassium (K), Sodium (Na), Calcium (Ca), Lithium (Li) and other blood elements.

15. The method according to claim 13, wherein the liquid is water tested for of anions: Chloride (Cl), Sulfate (SO4) and Bicarbonate (HCO3).

16. The method according to claim 13, wherein the liquid is water tested for cations: Potassium (K), Sodium (Na), Calcium (Ca) and Magnesium (Mg).

17. A method of testing a multitude of ions in blood or liquid simultaneously on a single biochip by applying capillary electrophoresis (CE).
